(19) United States
(12) Patent Application Publication
(10) Pub. No.: US 2020/0172057 A1
(43) Pub. Date: Jun. 4, 2020

(54) WHEEL DRUM BRAKE ASSEMBLY

(71) Applicant: MANDO CORPORATION, Pyeongtaek-si (KR)

(72) Inventor: Hatem SHAHIN, Pfaffenhofen (DE)

(21) Appl. No.: 16/695,691

(22) Filed: Nov. 26, 2019

(30) Foreign Application Priority Data
Nov. 30, 2018 (DE) 102018220763.1

(51) Int. Cl. B60T 1/06; F16D 65/00; F16D 65/10; F16D 65/78; F16D 65/02

(52) U.S. Cl. CPC B60T 1/067; F16D 65/0006; F16D 2065/1336; F16D 2065/785; F16D 65/10

(57) ABSTRACT

The invention at hand refers to a wheel drum brake assembly comprising a wheel rim and an annular brake ring with intermediate bridges, wherein the wheel rim and the annular brake ring are arranged in a concentric manner and the annular brake ring is connected to the wheel rim by the intermediate bridges such as to let air circulate between the inner surface of the wheel rim and the outer surface of the annular brake ring with a normal vector pointing in a radial direction of the annular brake ring. The wheel drum brake assembly also comprises a drum brake caliper with at least one brake shoe, wherein the caliper and the at least one brake shoe are arranged at the inner circumference of the annular brake ring.

### CROSS REFERENCE TO RELATED APPLICATION

This application claims priority under 35 U.S.C. § 119 to German Patent Application No. 102018220763.1, filed on Nov. 30, 2018 in the German Patent and Trade Mark Office (DPMA), the contents of which are herein incorporated by reference in their entirety.

### TECHNICAL FIELD

The present invention relates to a wheel drum brake assembly with a large friction radius.

### BACKGROUND

Drum brake systems typically comprise one brake ring and a caliper with at least one brake shoe. Thereby, the brake ring is fixed to the wheel such that pressing the brake shoe against the inner surface of the brake ring causes the wheel to decelerate.

An important aspect of designing better brake systems is to improve the noise, vibration and harshness (NVH) behaviour. For example, it is desirable to reduce the mass of the wheel drum brake assembly as much as possible without adversely affecting its mechanical stability and performance, e.g., in order to ensure good dynamical behaviour and to avoid brake noises at high frequencies (squeal noises).

A further objective is to maximize the friction radius in order to reduce the braking force. Theoretically, the friction radius could be almost as large as the inner radius of the wheel rim. Typically, the friction radius is largely limited by the size of the caliper and the coupling members by which the brake ring is fixed to the wheel.

A drum brake system with a large friction radius is shown in U.S. Pat. No. 4,159,832 A, where the brake ring is fixed via annular mating flanges to the wheel rim as well as to the wheel spider. However, fixing the brake ring to the wheel spider can lead to unwanted noise and unbalanced/asymmetric braking behaviour, which should be avoided.

### SUMMARY

Thus, the object of the invention at hand is to provide a simple and cost efficient design for a wheel drum brake assembly with a large friction radius and high standards regarding noise resilience and durability.

This object of the invention is achieved by the wheel drum brake assembly as described in claim 1. Advantageous developments and embodiments are described in the dependent claims.

A wheel drum brake assembly comprises a wheel rim and an annular brake ring with intermediate bridges, wherein the wheel rim and the annular brake ring are arranged in a concentric manner and the annular brake ring is connected to the wheel rim by the intermediate bridges such as to let air circulate between the inner surface of the wheel rim and the outer surface of the annular brake ring with a normal vector pointing in a radial direction of the annular brake ring.

The wheel drum brake assembly also comprises a drum brake caliper with at least one brake shoe, wherein the caliper and the at least one brake shoe are arranged at the inner circumference of the annular brake ring. The at least one brake shoe is configured to press against the inner surface of the annular brake ring in a radial direction of the annular brake ring during braking.

The proposed design allows to realize a large friction radius and integrates the annular brake ring and the wheel rim in a simple, stable and noise resilient way by means of intermediate bridges. In particular, squeal noises are strongly suppressed. The wheel drum brake assembly according to the invention also suppresses unwanted axial vibrations, drag torque and conning of the annular brake ring due to thermal load. Another advantage offered by the invention is to reduce costs, fuel consumption and CO₂ emission of a vehicle. A further advantage is efficient heat dissipation of the various parts of the wheel drum brake assembly. Another advantage is that all components of the proposed wheel drum brake assembly are easy to clean, e.g., in order to avoid brake dust. The proposed design further improves axial stiffness and NVH behaviour and allows to use light weight and compact calipers. For example, the supply lines for the brake fluid take up less space within the caliper housing.

The wheel drum brake assembly can also comprise an additional coupler ring arranged between the wheel rim and the annular brake ring in a concentric manner, wherein the outer surface of the coupler ring with a normal vector pointing in a radial direction of the coupler ring is connected to the inner surface of the wheel rim in a planar manner and the inner surface of the coupler ring is connected to the annular brake ring via the intermediate bridges. The coupler ring can add mechanical stability to the whole structure. Additionally, integrating the wheel rim and the annular brake ring via the coupier ring and the intermediate bridges helps to damp road vibrations through the wheel rubber.

In order to connect the wheel rim and the annular brake ring as well as the coupler ring, various attaching means can be utilized such as at least one bolt, press fit, welding or adhesive bonding or any combination thereof. In general, it is advantageous if as few components as possible are involved in the coupling mechanism. For example, the intermediate bridges themselves can be bolts fixing the annular brake ring to the wheel rim and/or to the coupler ring. Preferably, the coupler ring can be connected to the wheel rim and the annular brake ring through bolts only.

Preferably, the annular brake ring is fixed to the wheel rim only via the intermediate bridges, which are connected to an inner surface of the wheel rim. Alternatively, the intermediate bridges (and thereby also the annular brake ring itself) are connected to the coupler ring, which itself is connected to the wheel rim. This allows changing, i.e., assembling and disassembling, the various parts of the wheel drum brake assembly in a simple manner. Additionally, the annular brake ring may be coupled to a spoke that is detachable from the wheel rim. This may add further mechanical stability to the whole structure of the wheel drum brake assembly. Alternatively, the annular brake ring with the intermediate bridges may completely replace one or multiple spokes of the wheel.

In order to reduce the operating temperature of the wheel drum brake assembly adequate means for heat conduction and dissipation need to be provided. This can be achieved by a suitable choice of materials, as well as dimensional and geometrical considerations for the wheel rim, the annular brake ring, the intermediate bridges and the coupler ring as outlined in more detail below.

Preferably, the coupler ring is made of a thermally insulating material, e.g., a ceramic or a polymer material. The coupler ring can also be made of a metal or a metal alloy with low thermal conductivity, preferably a metal or metal alloy with a thermal conductivity that is smaller than the thermal conductivity of aluminium. Choosing a thermally insulating material for the coupler ring prevents that the temperature of the wheel rim increases considerably when the brake shoe engages with the annular brake ring and enormous amounts of heat are produced by friction. Otherwise, an increased wheel rim temperature may increase the tire pressure, which in turn can deteriorate driving performance especially during high performance driving such as car or motorbike racing.

Preferably, the coupler ring is also elastically deformable in order to provide a damping mechanism that compensates for deformations of the tires and/or wheel rim under rough driving conditions.

In some embodiments, the coupler ring can also be made of a thermally conducting material in order to facilitate an efficient heat transfer from the annular brake ring to the wheel rim. Heat generated by friction can generate porosity and defects such as cracks inside the annular brake ring as well as at its surface. Such defects can impact the braking behaviour and harm the durability of the annular brake ring. Providing means for transferring heat from the annular brake ring to the wheel rim makes it possible to counteract such brake ring fatigue problems.

In general, it is desirable to reduce the weight of the wheel drum brake assembly in order to reduce fuel consumption and CO₂ emission. Preferably, the wheel rim as well as the annular brake ring and the intermediate bridges are made of aluminium, an aluminium alloy, cast iron, stainless steel or a combination thereof.

The annular brake ring or at least parts of the annular brake ring can also be made of a suitable friction material, which increases friction between the annular brake ring and the brake shoe. Such a friction material can be applied as a coating layer on the inner surface or parts of the inner surface of the annular brake ring, which engages with the brake shoe. The frictional material may comprise steel, iron, copper, adhesive materials, asbestos materials or non-asbestos organics, aluminium, stainless steel or another metallic composite, oxide, carbide or any combination thereof. The friction coating layer can be disposed using various methods such as spraying or chemical vapour deposition.

A large radial thickness of the annular brake ring increases the surface area and the volume of the annular brake ring, thereby improving heat conduction and heat radiation. However, a small radial thickness of the annular brake ring reduces weight and thereby contributes to fuel and CO₂ efficiency. The radial thickness of the annular brake ring is preferably less than 80 mm, more preferably less than 60 mm. The width of the annular brake ring is preferably less than 100 mm, more preferably less than 80 mm.

The dimensions of the coupler ring should be chosen so as to provide a stable connection between the wheel rim and the annular brake ring. The radial thickness of the coupler ring is preferably less than 40 mm, more preferably less than 20 mm. The width of the coupler ring is preferably less than 60 mm, more preferably less than 40 mm.

The intermediate bridges dampen axial as well as radial vibrations of the annular brake ring. They can be realized as posts or columns spaced apart from one another. Alternatively, the intermediate bridges could be annular rings or sections of annular rings that are spaced apart from one another. The spacing between the intermediate bridges allows air to circulate between the wheel rim and the annular brake ring such that the outer surface of the annular brake ring with a normal vector pointing in a radial direction can be cooled efficiently. The intermediate bridges can be an integral part of the annular brake ring. In particular, the intermediate bridges can be made of the same material as the annular brake ring. The intermediate bridges could also be bolts via which the annular brake ring is fixed to the wheel rim or the coupler ring.

If the annular brake ring is directly fixed to the inner surface of the wheel rim without an additional coupler ring in between, the distance between the inner surface of the wheel rim and the outer surface of the annular brake ring is preferably less than 30 mm, more preferably less than 20 mm. In case the annular brake ring is fixed to the inner surface of the wheel rim via a coupler ring, the distance between the inner surface of the coupler ring and the outer surface of the annular brake ring is preferably less than 20 mm, more preferably less than 10 mm.

In order to improve reaction time and moment of the brake system, the intermediate bridges can provide additional elasticity for the annular brake ring. This is important for flawless functioning of the brake system in case of multiple braking events occurring in quick succession.

Preferably, the wheel rim, the coupler ring and the annular brake ring are arranged symmetrically with respect to each other such that the centroid of the wheel rim corresponds to the centroid of the annular brake ring and/or the centroid of the coupler ring corresponds to the centroid of the annular brake ring. Such an alignment helps to equally distribute the various forces acting during braking as well as driving without braking and improves the overall stability as well as NVH behaviour.

The caliper can be placed at any angular position along the inner circumference of the annular brake ring. In order to provide simple means for maintenance and cleaning of the wheel drum brake assembly, the caliper is preferably arranged with maximal distance from the point of contact between the wheel and the ground. It is also possible that the wheel drum brake assembly comprises a plurality of calipers with a plurality of breaking shoes in order to increase the braking force and effective braking surface.

The wheel drum brake assembly proposed by the invention at hand is suitable for various kinds of vehicles ranging from automobiles, motorbikes, buses and trucks to agricultural machinery and aircrafts.

Exemplary embodiments of the invention are illustrated in the drawings and will be explained below with reference to FIGS. 1 and 2.

### BRIEF DESCRIPTION OF THE DRAWINGS

FIG. 1 shows a schematic side view of the wheel drum brake assembly,

FIG. 2 shows a schematic cross section of the wheel drum brake assembly along the line A-A in FIG. 1.

### DETAILED DESCRIPTIONS

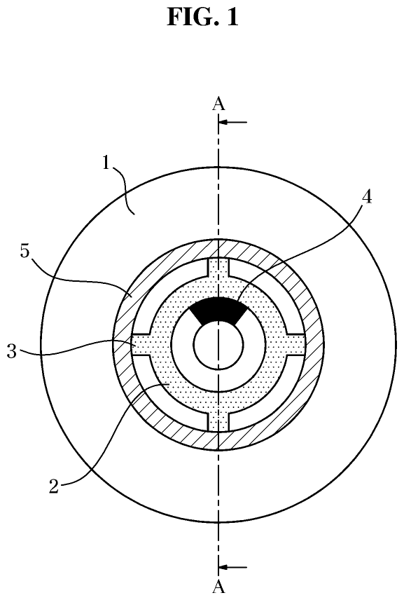

FIG. 1 shows a schematic side view of a wheel drum brake assembly comprising a wheel rim 1, a coupler ring 5 and an annular brake ring 2 arranged in a concentric manner. Intermediate bridges 3 are an integral part of the annular brake ring 2 and are connected to the inner surface of the coupler ring 5. The intermediate bridges 3 are arranged equidistantly around the circumference of the annular brake ring 2.

An outer surface of the coupler ring 5 with a normal vector pointing in a radial direction connects to an inner surface of the wheel rim 1 in a planar manner. An outer surface of the annular brake ring 2 with a normal vector pointing in a radial direction is arranged at a distance from the inner surface of the coupler ring 5, wherein the annular brake ring 2 and the coupler ring 5 are connected via intermediate bridges 3 arranged between the inner surface of the coupler ring 5 and the outer surface of the annular brake ring 2 with a normal vector pointing in a radial direction. A drum brake caliper 4 is arranged at the inner circumference of the annular brake ring 2 with maximal distance to ground.

The wheel rim 1 and the annular brake ring 2 as well as the intermediate bridges 3 are made of aluminium taking advantage of its low mass and high thermal conductivity, which improves heat dissipation and avoids conning and hot spots. The coupler ring 5 is made of an elastic polymer, which provides thermal insulation for the wheel rim 1.

The wheel rim 1 and the intermediate bridges 3 are connected to the coupler ring 5 via bolts. Alternatively, the intermediate bridges 3 can be realized as bolts directly fixing the annular brake ring 2 to the inner surface of the coupler ring 5. The connection between the coupler ring 5 and the intermediate bridges 3 or between the coupler ring 5 and the wheel rim 1 may alternatively or additionally be realized by a press fit, welding or adhesive bonding.

The braking surface of the annular brake ring 2, which is a part of the inner surface of the annular brake ring 2, comprises a friction material applied as a coating layer made of a metallic composite with good adhesion to aluminium such as a stainless steel composite.

In the depicted embodiment, the radial thickness of the coupler ring 5 is between 10 mm and 20 mm. The width of the coupler ring 5 is between 30 mm and 40 mm. The radial thickness of the annular brake ring 2 is between 40 mm and 60 mm. The width of the annular brake ring 2 is between 60 mm and 80 mm. The distance between the inner surface of the coupler ring 5 and the outer surface of the annular brake ring 2 with a normal vector pointing in a radial direction is between 5 mm and 15 mm.

All three concentric components, i.e., the wheel rim 1, the coupler ring 5 and the annular brake ring 2 are arranged symmetrically and share a common centroid.

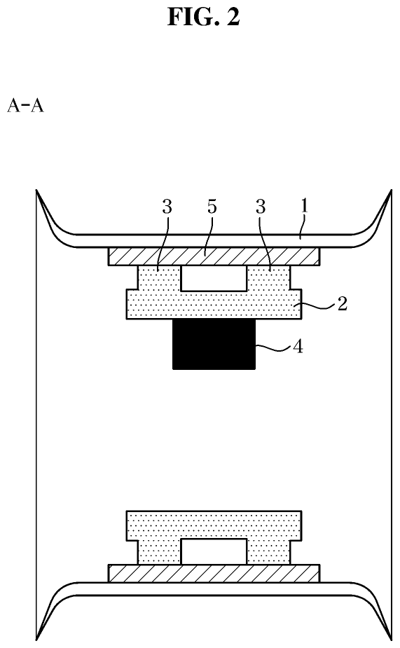

A cross sectional view of the wheel drum brake assembly along line A-A in FIG. 1 is shown in FIG. 2. Recurring features in the figures in each case are denoted with identical reference signs. The caliper 4 comprises a brake shoe arranged inside the caliper housing. The brake shoe is configured to move towards the inner surface of the annular brake ring 2 and press against the annular brake ring 2 for braking.

FIG. 1 and FIG. 2 depict four pairs of intermediate bridges 3, where each pair of intermediate bridges 3 is arranged on a common line that is parallel to the axis of rotation. It is also possible that more or less pairs of intermediate bridges 3 connect the annular brake ring 2 and the coupler ring 5. In particular, the intermediate bridges 3 can replace the spokes of the wheel such that no separate system of spokes is necessary. Alternatively, the annular brake ring 2 can be coupled to a separate spoke that is detachable from the wheel rim 1.

Features of the different embodiments which are merely disclosed in the exemplary embodiments as a matter of course can be combined with one another and can also be claimed individually.

What is claimed is:

1. A wheel drum brake assembly comprising
a wheel rim and an annular brake ring with intermediate bridges, wherein the wheel rim and the annular brake ring are arranged in a concentric manner and the annular brake ring is connected to the wheel rim by the intermediate bridges and
said intermediate bridges are arranged such as to let air circulate between the wheel rim and the outer surface of the annular brake ring with a normal vector pointing in a radial direction of the annular brake ring,
a drum brake caliper with at least one brake shoe, wherein the caliper and the at least one brake shoe are arranged at the inner circumference of the annular brake ring and the at least one brake shoe is configured to press against the inner surface of the annular brake ring in a radial direction of the annular brake ring during braking.

2. Wheel drum brake assembly according to claim 1, characterized in that a coupler ring is arranged between the wheel rim and the annular brake ring in a concentric manner, wherein
the outer surface of the coupler ring with a normal vector pointing in a radial direction of the coupler ring is connected to the inner surface of the wheel rim in a planar manner and
the inner surface of the coupler ring is connected to the intermediate bridges.

3. Wheel drum brake assembly according to claim 2, characterized in that the coupler ring is made of a thermally insulating material and/or an elastically deformable material.

4. Wheel drum brake assembly according to claim 2, characterized in that the coupler ring is connected to the wheel rim and/or the intermediate bridges via at least one bolt, press fit, welding or adhesive bonding.

5. Wheel drum brake assembly according to claim 1, characterized in that the annular brake ring is coupled to a spoke detachable from the wheel rim.

6. Wheel drum brake assembly according to claim 1, characterized in that the wheel rim and/or the annular brake ring comprises aluminium and/or cast iron and/or stainless steel.

7. Wheel drum brake assembly according to claim 1, characterized in that a friction material coating is applied to at least a part of the inner surface of the annular brake ring comprising steel, iron, copper, adhesive materials, asbestos materials or non-asbestos organics.

8. Wheel drum brake assembly according to claim 1, characterized in that the radial thickness of the annular brake ring is less than 60 mm
and/or
the width of the annular brake ring is less than 80 mm.

9. Wheel drum brake assembly according to claim 1, characterized in that the intermediate bridges are an integral part of the annular brake ring and made of the same material as the annular brake ring.

10. Wheel drum brake assembly according to claim 1, characterized in that the intermediate bridges are bolts by which the annular brake ring is fixed to the wheel rim.

11. Wheel drum brake assembly according to claim 1, characterized in that the centroid of the annular brake ring corresponds to the centroid of the wheel rim.
